(19) United States
(12) Patent Application Publication
(10) Pub. No.: US 2006/0010336 A1
(43) Pub. Date: Jan. 12, 2006

(54) Connection apparatus and method for network testers and analysers

(75) Inventors: Kenneth McPherson Hopkins, Chichester (GB); Howard W. Winter, Southampton (GB)

Correspondence Address: PILLSBURY WINTHROP SHAW PITTMAN, LLP, P.O. BOX 10500, MCLEAN, VA, 22102, US

(73) Assignee: Xyratex Technology Limited, Havant, Hampshire, GBN (GB)

(21) Appl. No.: 10/530,672

(22) PCT Filed: Oct. 2, 2003
(86) PCT No.: PCT/GB03/04246

§ 371 Date: Apr. 8, 2005

Related U.S. Application Data
(60) Provisional application No. 60/416,964, filed on Oct. 9, 2002.

(51) Int. Cl. G06F 11/00

(52) U.S. Cl. 714/4

(57) ABSTRACT

Connection apparatus for a network tester or analyser comprises at least two network connection devices for connecting the apparatus to a network and at least two solid state switches. Each connection device is constructed and arranged to output serial electrical signals corresponding to signals received from a network to which the connection is in use connected. Each solid state switch is constructed and arranged to receive serial electrical signals output by a respective one of the network connection devices and to output a corresponding serial electrical signal. Each solid state switch is controllable such that electrical signals corresponding to signals received from the network can selectively be output by the solid state switch and received at the other or another of the solid state switches for return to the network by said other or another of the solid state switches.

The present invention relates to connection apparatus and methods for network testers and analysers.

Network testers are commonly used to test certain elements of a network. For example, a network tester may test the integrity of physical aspects of the network, such as the cables (such as electric wires or fibre optics), and/or logical aspects. This may be done by the network tester generating (dummy) network traffic that is passed to the network and then subsequently analysed. On the other hand, a network analyser, also known as a protocol analyser or a network monitor, analyses data passing along the network, typically by capturing and/or copying data packets from the network and carrying out various analyses on the data packets.

Network analysers are often connected in in-line mode. In other words, the network analyser is effectively connected between two network devices, capturing data packets passing between the two network devices whilst not affecting the passage of data packets between the network devices. Where the network is an electrical network, this may require that the network analyser provide copies of the captured data packets back to the network. Where the network is an optical network, the connection arrangement for the network analyser typically only splits off a portion of the light such that it is not necessary for captured data packets to be copied back to the network by the analyser. Network testers tend in practice to be connected only in end station mode. Nevertheless, in the case of both network testers and network analysers, it can be convenient to be able to selectively connect the tester or analyser such that it operates in in-line mode or end station mode at the option of the user.

Many network testers and analysers are constructed so that they can operate only in in-line or in end station mode, and the user is unable to change the configuration of the network tester or analyser to operate in the other mode. One known way of allowing a network tester or analyser to be switched between end station or in-line mode at the option of the operator is to use mechanical switches or relays within the tester or analyser to switch the signal paths appropriately. However, mechanical switches or relays are preferably avoided in network analysers or testers that are used with high transmission rate networks because they can leave undesirable artefacts on the signals passing to and/or from the network tester or analyser.

According to a first aspect of the present invention, there is provided connection apparatus for a network tester or analyser, the connection apparatus comprising: at least two network connection devices for connecting the apparatus to a network, each connection device being constructed and arranged to output serial electrical signals corresponding to signals received from a network to which the connection apparatus is in use connected; and, at least two solid state switches, each solid state switch being constructed and arranged to receive serial electrical signals output by a respective one of the network connection devices and to output a corresponding serial electrical signal; each solid state switch being controllable such that electrical signals corresponding to signals received from a said network can selectively be output by the solid state switch and received at the other or another of the solid state switches for return to a said network by said other or another of the solid state switches.

The use of controllable solid state switches provides a simple and flexible connection topology. The connection apparatus can be connected to or formed as part of the “front end” a network tester or analyser so that the tester or analyser can be connected to a network to operate in in-line or end station mode at the option of the operator. Because the switches deal with electrical signals at the serial level, minimal or practically negligible latency is introduced into the electrical signals as they are handled by the switches. This is particularly important in high speed networks, such as those operating at rates of gigabits per second or higher. The connection apparatus can be embodied on a single printed circuit board, which may be part of a network tester or analyser.

The connection apparatus may comprise a respective serial-to-parallel data converter for each solid state switch, each serial-to-parallel data converter being constructed and arranged to receive a serial electrical signal corresponding to signals received from a said network that is output by the respective solid state switch and to convert the received serial electrical signal into parallel form. The output parallel signals can be passed further into a network tester or analyser for testing/analysis purposes in a manner known per se.

Each solid state switch is preferably constructed and arranged to retime electrical signals received from the other or another of the solid state switches prior to returning said electrical signals to a said network. The use of retiming is particularly advantageous when operating in in-line mode as it ensures that the integrity of the data returned to the network is preserved. This is valuable in any network protocol but is particularly useful where the network uses the Fibre Channel standard as it can help to avoid the need for fill words to be added to or removed from the data that is returned to the network. It will be understood that the need to add or remove fill words adds to the complexity and therefore cost of a network analyser. Avoiding this also means that the network analyser interferes with the data as little as possible. Retiming at the serial level also avoids the process of de-serialisation, decoding, skew management, and re-serialisation. In other words, when retiming at the serial level, the solid state switch effectively retimes the signal to itself by locking onto the incoming serial data and generating a periodic clock signal which is then used to derive the transmitted data. This reduces the unwanted effects of transmission across optical or copper medium which would be associated with for example simply buffering the input signal. In Fibre Channel when retiming is done at a higher level, i.e. after de-serialisation and. decoding, etc., then so-called skew management (i.e. the use of addition or removal of fill words) is required because the signal is retimed to a new reference clock.

Preferably, at least one of the solid state switches is a port bypass circuit. In a preferred embodiment, each solid state switch is a port bypass circuit. Port bypass circuits, which are known per se for connecting network devices, are typically well adapted for use with high speed networks. The preferred port bypass circuits provide the retiming function discussed above.

Each network connection device may be constructed and arranged to receive optical signals from an optical network and to convert the received optical signals into serial electrical form for output to the respective solid state switch.

According to a second aspect of the present invention, there is provided connection apparatus for network testers and analysers, the connection apparatus comprising: two network connection devices for connecting the apparatus to a network, each connection device being constructed and arranged to output serial electrical signals corresponding to signals received from a network to which the connection apparatus is in use connected; and, two port bypass circuits, each port bypass circuit having at least three output ports, each port bypass circuit being constructed and arranged to receive serial electrical signals output by a respective one of the network connection devices and to output a corresponding serial electrical signal on a first of its output ports; each port bypass circuit being controllable such that electrical signals corresponding to signals received from a said network can selectively be output on a second of the output ports of the port bypass circuit and received at the other port bypass circuit for return to a said network via a third of the output ports of the other port bypass circuit.

As mentioned above, port bypass circuits are typically well adapted for use with high speed networks.

The connection apparatus may comprise a respective serial-to-parallel data converter for each port bypass circuit, each serial-to-parallel data converter being constructed and arranged to receive a serial electrical signal corresponding to signals received from a said network that is output on the first port of the respective port bypass circuit and to convert the received serial electrical signal into parallel form.

Each port bypass circuit is preferably constructed and arranged to retime electrical signals received from the other or another of the port bypass circuits prior to returning said electrical signals to a said network.

According to another aspect of the present invention, there is provided a network tester comprising connection apparatus as described above so that the network tester can selectively be operated in in-line or end station mode when connected to a network.

According to another aspect of the present invention, there is provided a network analyser comprising connection apparatus as described above so that the network analyser can selectively be operated in in-line or end station mode when connected to a network.

According to another aspect of the present invention, there is provided a method of operating connection apparatus for a network tester or analyser, the connection apparatus comprising at least two network connection devices for connecting the apparatus to a network, each connection device being constructed and arranged to output serial electrical signals corresponding to signals received from the network; and, at least two solid state switches, each solid state switch being constructed and arranged to receive serial electrical signals output by a respective one of the network connection devices and to output a corresponding serial electrical signal; the method comprising: selectively controlling each solid state switch such that electrical signals corresponding to signals received from the network are output by the solid state switch and received at the other or another of the solid state switches for return to the network by said other or another of the solid state switches whereby the apparatus operates in in-line mode, or such that electrical signals corresponding to signals received from the network and output by each solid state switch are not received at the other or another of the solid state switches whereby the apparatus operates in end station mode.

According to another aspect of the present invention, there is provided a method of operating connection apparatus for network testers and analysers, the connection apparatus comprising: two network connection devices for connecting the apparatus to a network, each connection device being constructed and arranged to output serial electrical signals corresponding to signals received from a network to which the connection apparatus is in use connected; and, two port bypass circuits, each port bypass circuit having at least three output ports, each port bypass circuit being constructed and arranged to receive serial electrical signals output by a respective one of the network connection devices and to output a corresponding serial electrical signal on a first of its output ports; the method comprising: selectively controlling each port bypass circuit such that electrical signals corresponding to signals received from the network are output on a second of the output ports of the port bypass circuit and received at the other port bypass circuit for return to the network via a third of the output ports of the other port bypass circuit whereby the apparatus operates in in-line mode, or such that electrical signals corresponding to signals received from the network and output by each port bypass circuit are not received at the other port bypass circuit whereby the apparatus operates in end station mode.

Embodiments of the present invention will now be described by way of example with reference to the accompanying drawing, in which:

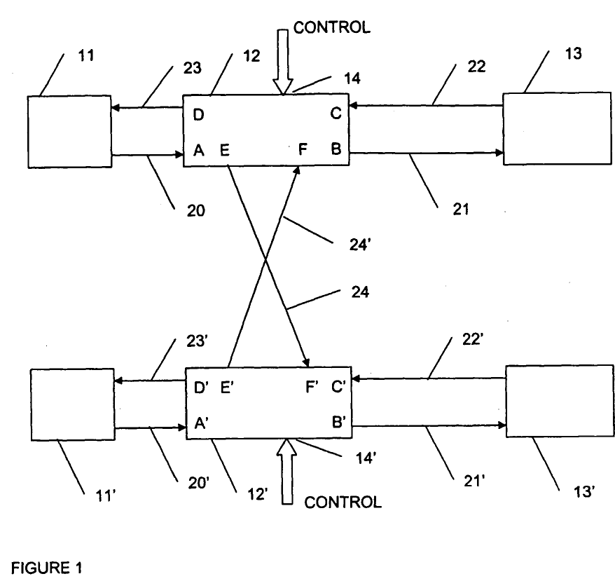

FIG. 1 is a schematic block diagram of an example of connection apparatus according to an embodiment of the present invention.

Referring to the drawing, an example of connection apparatus 10 in accordance with an embodiment of the present invention is used as a front end of a network tester or analyser (not shown). The connection apparatus 10 may be connected to or integrally formed with the network tester or analyser. The connection apparatus 10 has two network connection devices 11,11′ which allow the connection apparatus 10 to receive signals from a network (not shown) to which the connection apparatus 10 is in use connected. The network connection devices 11,11′ provide output serial electrical signals 20,20′. Where the network is an optical network, each network connection device 11,11′ may be such as to convert the received optical signals into the output electrical signals 20,20′.

The output electrical signals 20,20′ are passed to respective solid state switches 12,12′. The solid state switches 12,12′ are such as to be able to cope with the physical link rate of the network. As will be discussed further below, each switch 12,12′ of the preferred embodiment is a so-called port bypass circuit.

Each switch 12,12′ of this example has a control input 14,14′ on which control signals for controlling the operation of the switch 12,12′ can be presented. Each switch 12,12′ of this example further has plural input and output ports which are arranged as follows.

Each switch 12,12′ has a first input port A,A′ at which the electrical signals 20,20′ from the respective network connection devices 11,11′ are received. Each switch 12,12′ outputs on a first output port B,B′ a serial electrical signal 21,21′ corresponding to the electrical signals 20,20′ received at its input port A,A′, the output serial electrical signals 21,21′ being passed to a respective SERDES 13,13′. In the preferred embodiment, the output serial electrical signals 21,21′ are always sent to the respective SERDES 13,13′ when the network tester or analyser is operating.

Each SERDES 13,13′ provides for serial-to-parallel conversion of the received serial electrical signals 21,21′, the parallel signals being passed to known components of the network tester or analyser. Correspondingly, each SERDES 13,13′ can receive parallel signals and convert them to serial form which is output as serial electrical signals 22,22′ which are returned to a second input port C,C′ of the respective switches 12,12′.

Each switch 12,12′ has a second output port D,D′ on which electrical signals 23,23′ are output to the respective network connection device 11,11′. Each switch 12,12′ has a third output port E,E′ on which electrical signals 24,24′ can be output to be received at a third input port F′,F of the other switch 12′,12.

The control signals presented at the control inputs 14,14′ of the switches 12,12′ cause the switches 12,12′ to be configured so as to enable the connection apparatus 10 to be operated either in in-line mode or end station mode at the option of the operator. In particular, the control signals cause the various input and output ports A-F,A′-F′ to be connected as follows.

In in-line mode, the switches 12,12′ are controlled so that the electrical signals 20 received at the first input port A are copied so as to be output on the third output port E and passed as the electrical signals 24 to the third input port F′ of the other switch 12′ (and correspondingly for the electrical signals 20′ received at the first input port A′ of the other switch 12′). This is in addition to the passing of the electrical signal 21 from the first output port B to the SERDES 13 (and correspondingly for the other switch 12′). The third input port F′ of the other switch 12′ passes the received electrical signal 24 to the second output port D′ where it is passed as the output electrical signal 23′ to the respective network connection device 11′ (and correspondingly for the other switch 12). In the preferred embodiment, the signal passing between the third input port F,F′ to the second output port D,D′ is regenerated by the switch 12,12′ in order to restore signal amplitude and retimed to reduce jitter, thus improving signal integrity such that the ongoing signal passed back to the network is less degraded. It will be appreciated that this arrangement provides for a crossover path from one half of the connection apparatus 10 to the other, thus providing a duplex path in both directions.

On the other hand, when operating in end station mode, the third output ports E,E′ of-the switches 12,12′ are not arranged to receive signals from the first input ports A,A′ and so do not transmit signals to the other switch 12′,12. On the contrary, the signals 23 that are passed to the network connection devices 11,11′ correspond to the signals 22,22′ received at the second input ports C,C′. It will be appreciated that in this end station mode, the two halves of the connection apparatus 10 can operate as independent end port stations, each capable of transmitting and receiving.

Accordingly, in a simple and effective manner, the connection apparatus 10 can be controlled by an operator so that the connection apparatus 10 can be used selectively in in-line or end station mode at the option of the operator.

In the preferred embodiment, as briefly mentioned above, the switches 12,12′ are so-called port bypass circuits. Suitable port bypass circuits include the Max3755 from Maxim, the VSC7147 from Vitesse, and the HDMP-0552 from Agilent. Each of these provides optionally for regeneration of a received electrical signal to provide for clock and data recovery so that when the connection apparatus 10 is operating in in-line mode, the integrity of the signal returned to the network is maintained. Such port bypass circuits have conventionally been used only to interconnect network devices, such as disk drives, personal computers, etc.

Embodiments of the present invention have been described with particular reference to the examples illustrated. However, it will be appreciated that variations and modifications may be made to the examples described within the scope of the present invention.

1. Connection apparatus for a network tester or analyser, the connection apparatus comprising:
at least two network connection devices for connecting the apparatus to a network, each connection device being constructed and arranged to output serial electrical signals corresponding to signals received from a network to which the connection apparatus is in use connected; and,
at least two solid state switches, each solid state switch being constructed and arranged to receive serial electrical signals output by a respective one of the network connection devices and to output a corresponding serial electrical signal;
each solid state switch being controllable such that electrical signals corresponding to signals received from a said network can selectively be output by the solid state switch and received at the other or another of the solid state switches for return to a said network by said other or another of the solid state switches.

2. Connection apparatus according to claim 1, comprising a respective serial-to-parallel data converter for each solid state switch, each serial-to-parallel data converter being constructed and arranged to receive a serial electrical signal corresponding to signals received from a said network that is output by the respective solid state switch and to convert the received serial electrical signal into parallel form.

3. Connection apparatus according to claim 1, wherein each solid state switch is constructed and arranged to retime electrical signals received from the other or another of the solid state switches prior to returning said electrical signals to a said network.

4. Connection apparatus according to claim 1, wherein at least one of the solid state switches is a port bypass circuit.

5. Connection apparatus according to claim 4, wherein each solid state switch is a port bypass circuit.

6. Connection apparatus according to claim 1, wherein each network connection device is constructed and arranged to receive optical signals from an optical network and to convert the received optical signals into serial electrical form for output to the respective solid state switch.

7. Connection apparatus for network testers and analysers, the connection apparatus comprising:
two network connection devices for connecting the apparatus to a network, each connection device being constructed and arranged to output serial electrical signals corresponding to signals received from a network to which the connection apparatus is in use connected; and,
two port bypass circuits, each port bypass circuit having at least three output ports, each port bypass circuit being constructed and arranged to receive serial electrical signals output by a respective one of the network connection devices and to output a corresponding serial electrical signal on a first of its output ports;
each port bypass circuit being controllable such that electrical signals corresponding to signals received from a said network can selectively be output on a second of the output ports of the port bypass circuit and received at the other port bypass circuit for return to a said network via a third of the output ports of the other port bypass circuit.

8. Connection apparatus according to claim 7, comprising a respective serial-to-parallel data converter for each port bypass circuit, each serial-to-parallel data converter being constructed and arranged to receive a serial electrical signal corresponding to signals received from a said network that is output on the first port of the respective port bypass circuit and to convert the received serial electrical signal into parallel form.

9. Connection apparatus according to claim 7, wherein each port bypass circuit is constructed and arranged to retime electrical signals received from the other or another of the port bypass circuits prior to returning said electrical signals to a said network.

10. A network tester comprising connection apparatus according to claim 7 so that the network tester can selectively be operated in in-line or end station mode when connected to a network.

11. A network analyser comprising connection apparatus according to claim 7 so that the network analyser can selectively be operated in in-line or end station mode when connected to a network.

12. A method of operating connection apparatus for a network tester or analyser, the connection apparatus comprising at least two network connection devices for connecting the apparatus to a network, each connection device being constructed and arranged to output serial electrical signals corresponding to signals received from the network; and, at least two solid state switches, each solid state switch being constructed and arranged to receive serial electrical signals output by a respective one of the network connection devices and to output a corresponding serial electrical signal; the method comprising:
selectively controlling each solid state switch such that electrical signals corresponding to signals received from the network are output by the solid state switch and received at the other or another of the solid state switches for return to the network by said other or another of the solid state switches whereby the apparatus operates in in-line mode, or such that electrical signals corresponding to signals received from the network and output by each solid state switch are not received at the other or another of the solid state switches whereby the apparatus operates in end station mode.

13. A method according to claim 12, comprising converting from serial to parallel form a serial electrical signal corresponding to signals received from the network that is output by one of the solid state switches.

14. A method according to claim 12, comprising retiming electrical signals received from the other or another of the solid state switches prior to returning said electrical signals to the network.

15. A method according to claim 12, wherein at least one of the solid state switches is a port bypass circuit.

16. A method according to claim 15, wherein each solid state switch is a port bypass circuit.

17. A method according to claim 12, comprising receiving optical signals from an optical network at each network connection device and converting the received optical signals into serial electrical form for output to the respective solid state switch.

18. A method of operating connection apparatus for network testers and analysers, the connection apparatus comprising: two network connection devices for connecting the apparatus to a network, each connection device being constructed and arranged to output serial electrical signals corresponding to signals received from a network to which the connection apparatus is in use connected; and, two port bypass circuits, each port bypass circuit having at least three output ports, each port bypass circuit being constructed and arranged to receive serial electrical signals output by a respective one of the network connection devices and to output a corresponding serial electrical signal on a first of its output ports; the method comprising:
selectively controlling each port bypass circuit such that electrical signals corresponding to signals received from the network are output on a second of the output ports of the port bypass circuit and received at the other port bypass circuit for return to the network via a third of the output ports of the other port bypass circuit whereby the apparatus operates in in-line mode, or such that electrical signals corresponding to signals received from the network and output by each port bypass circuit are not received at the other port bypass circuit whereby the apparatus operates in end station mode.

19. A method according to claim 18, comprising converting from serial to parallel form a serial electrical signal corresponding to signals received from the network that is output on the first port of one of the port bypass circuits.

20. A method according to claim 18, comprising retiming electrical signals received from the other or another of the port bypass circuits prior to returning said electrical signals to the network.

21. A network tester comprising connection apparatus according to claim 1 so that the network tester can selectively be operated in in-line or end station mode when connected to a network.

22. A network analyser comprising connection apparatus according to claim 1 so that the network analyser can selectively be operated in in-line or end station mode when connected to a network.
